(19) United States
(12) Patent Application Publication
(10) Pub. No.: US 2006/0191763 A1
(43) Pub. Date: Aug. 31, 2006

(54) Clutching device

(76) Inventor: Mark A. Joki, Dover, OH (US)

Correspondence Address: MICHAEL BEST & FRIEDRICH, LLP, 100 E WISCONSIN AVENUE, MILWAUKEE, WI, 53202, US

(21) Appl. No.: 10/552,003

(22) PCT Filed: Oct. 20, 2004
(86) PCT No.: PCT/US04/34656

§ 371 Date: Oct. 4, 2005

Related U.S. Application Data
(60) Provisional application No. 60/512,714, filed on Oct. 20, 2003.

(51) Int. Cl. F16D 41/08

(52) U.S. Cl. 192/48.91

(57) ABSTRACT

A clutching device comprising a generally cylindrical tubular slipper having a friction surface, a bearing surface, and first interlocking member. The bearing surface has radial projections which form axially oriented recesses. A generally cylindrical coupling member has a mounting surface, a bearing surface and a second interlocking member. The bearing surface has radial projections which form axially oriented recesses such that the tubular slipper recesses and the coupling member recesses form pockets in which said rollers are located. The tubular slipper and coupling member are axially displaceable relative to one another between a first position wherein the first and second interlocking members are engaged such that the coupling member and the tubular slipper recesses are maintained in alignment and a second position wherein the first and second interlocking members are disengaged and the coupling member and the tubular slipper are free to rotate relative to one another such that the coupling member and tubular slipper recesses are misalignable.

### BACKGROUND

The present invention relates to clutching devices. More particularly, the present invention relates to a clutching device for selectively coupling a gear to a shaft.

Referring to FIG. 1, a prior art clutching device for clutching a small gear 1 or a larger gear 2 to a shaft 3 upon which the gears 1, 2 are rotatably mounted is shown. To couple the shaft 3 to the small gear 1, which is rotating at a different speed than the shaft 3, a shift fork 6 is moved towards the small gear 1. The shift fork 6 pushes against ring 7 which is rotationally fixed to shaft 3, but axially moveable. The inner teeth edge of ring 7 contact and drive outer cone member 5 which in turn, contacts and applies rotational torque to the inner cone member 4 which is rotationally fixed to the small gear 1. The profile on the edge of inner teeth of ring 7 and the edge of outer teeth on outer cone member 5 block further axial movement of ring 7 while accelerating torque is being transferred from ring 7 to outer cone member 5. When the small gear 1 is approximately the same speed as the shaft 3, there is no longer significant accelerating torque transmitted and the ring 7 is no longer axially blocked by the outer cone member 4, allowing it to axially move to engage the outer teeth of inner cone member 4 which rotationally fixes the small gear 1 to the shaft 3. The larger gear 2 is coupled to the shaft 3 in a similar manner by moving the shift fork 6 toward the larger gear 2.

U.S. Pat. No. 6,409,001 discloses a clutching device that can selectively couple a gear to a shaft. This device requires a number of parts that are needed to engage and disengage the clutch.

### SUMMARY

The present invention provides a clutching device comprising a generally cylindrical tubular slipper having a friction surface, a bearing surface and a first interlocking member. The bearing surface has radial projections which form axially oriented recesses. A generally cylindrical coupling member has a mounting surface, a bearing surface and a second interlocking member. The bearing surface has radial projections which form axially oriented recesses such that the tubular slipper recesses and the coupling member recesses form pockets in which said rollers are located. The tubular slipper and coupling member are axially displaceable relative to one another between a first position wherein the first and second interlocking members are engaged such that the coupling member and tubular slipper recesses are maintained in alignment and a second position wherein the first and second interlocking members are disengaged and the coupling member and the tubular slipper are free to rotate relative to one another such that the coupling member and tubular slipper recesses are misalignable. The present invention provides a novel actuation method that requires no ancillary parts for actuation. This invention replaces a cone type synchronizer device with a lower cost and narrower device.

### BRIEF DESCRIPTION OF THE DRAWINGS

FIG. 1 is a longitudinal sectional view of a gear pair with a cone synchronizer mounted on a shaft as in a manual transmission.

FIG. 2 is a longitudinal sectional view of a gear pair with a clutching device of the present invention mounted on a shaft as in a manual transmission.

FIG. 3 is a fragmentary end view of the gear, synchronizers, and shaft taken along line 3-3 of FIG. 2 with the synchronizer being disengaged.

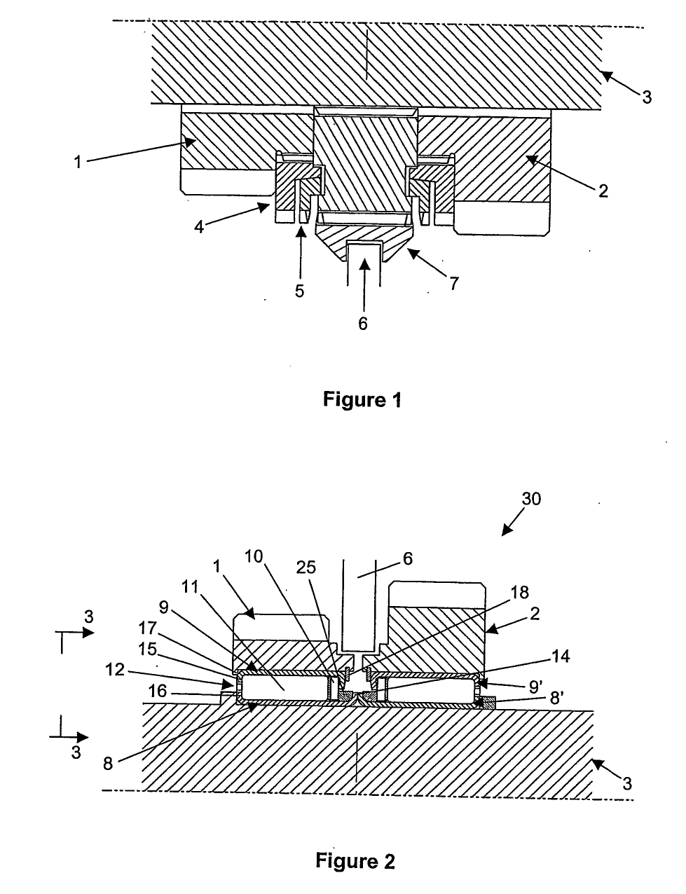

### DESCRIPTION OF THE PREFERRED EMBODIMENTS

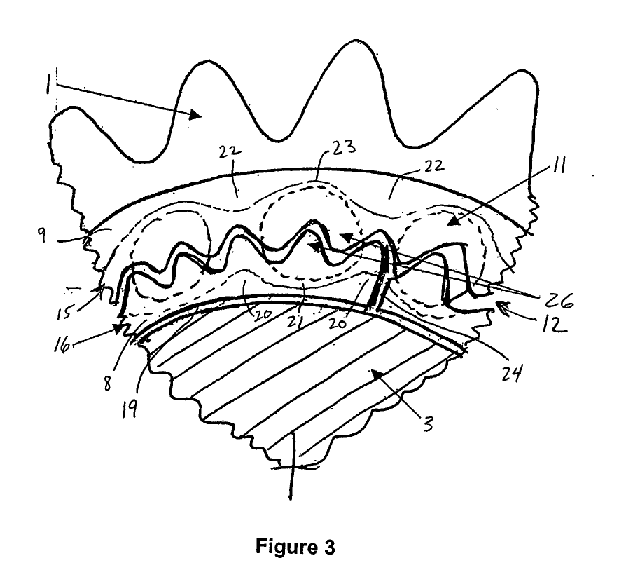

Referring to FIGS. 2 and 3, a clutching device 30 that is a first embodiment of the present invention will be described. The clutching device 30 includes a tubular slipper 8 loosely fit over shaft 3. The inner periphery of the tubular slipper 8 forms a cylindrical frictional surface 19. The outer periphery of the tubular slipper 8 has a bearing surface with radial projections 20 forming a series of axial recesses 21 as described in U.S. Pat. No. 6,409,001. The tubular slipper 8 is not fully circular but has an axial gap 24 to facilitate radial contraction (see FIG. 3).

A coupling member 9 has a cylindrical outer periphery press-fit into the small gear 1. The coupling member 9 is preferably retained axially with respect to the small gear 1 by a shoulder 17 formed on the small gear 1 and a snap ring 18 retained by the small gear 1. Other means may also be utilized to axially retain the coupling member 9 with respect to the small gear 1. The inner cylindrical surface of the coupling member 9 has a bearing surface with radial projections 22 forming a series of axial recesses 23 in a similar pattern to the tubular slipper 8. Rollers 11 are placed in the radial gap formed between the tubular slipper 8 and the coupling member 9—indeed, in the recesses 21, 23 in the tubular slipper 8 and the coupling member 9.

On one end of both the tubular slipper 8 and the coupling member 9 are formed first radial flanges 15, 16 with a rotationally interlocking feature 12. In the preferred embodiment, the interlocking feature 12 includes a series of internal and external involute splines 26 formed on the radial flanges 15, 16. Other means for interlocling the tubular slipper 8 and coupling member 9 may also be utilized. When the interlocking feature 12 is engaged, the recesses 19 in the tubular slipper 8 and the recesses 23 in the coupling member 9 are substantially radially opposed, creating looseness of the rollers 11 between these two members 8 and 9.

A second radial flange 14 on the tubular slipper 8 traps the rollers 11. A wave spring 10 is positioned between the rollers 11 and a spacer 25 in contact with the flange 14. The wave spring 10 keeps the rollers 11 seated against the first radial flange 16 of the tubular slipper 8. A second radial flange 13 on the coupling member 9 also traps the rollers 11. The wave spring 10 acts between the rollers 11 the flange 13 of the coupling member 9 to bias the coupling member 9 to the right, as illustrated, thereby maintaining the interlocking feature 12 in an engaged positioned. In this condition, the tubular slipper 8 is loose on the shaft 3 and very little torque transfers between the small gear 1 and the shaft 3.

When driving through the small gear 1 is desired, the shift fork 6 pushes the small gear 1 to the left, causing the coupling member 9 to move with it against the force of the spring 10. The tubular slipper 8 is retained axially, and therefore, the coupling member 9 moves axially relative to the tubular slipper 8, with the coupling member flange 15 moving out of axial alignment with the tubular slipper flange 16. As such, the interlocking feature 12 splines 26 disengage from each other and the coupling member 9 and tubular slipper 8 are rotatable relative to one another. The driven small gear 1 moves relative to the shaft 3 and experiences a slight drag from the contact of the tubular slipper 8 on the shaft 3. The drag torque causes the tubular slipper 8 to move relative to the coupling member 9, causing the rollers 11 to contact the sides of the recesses 21, 23. The contact of the rollers 11 with the recesses 21, 23 causes the tubular slipper 8 to reduce in diameter, which increases the drag torque. The high pressure angle of the contact of the rollers 11 with the sides of recesses 21, 23, causes the tubular slipper 8 to lock on the shaft 3 and power is transferred from the small gear 1 to the shaft 3 by the friction caused by the high normal forces of the tubular slipper 8 on the shaft 3.

The present clutching device 30 has been described with respect the small gear 1. The larger gear 2 is aligned with a second tubular slipper 8′ and coupling member 9′ and functions in the same manner as previously described. While the present invention is described with respect to a shaft having small and larger gears 1 and 2, the clutching device 30 may be utilized with various shaft and gear assemblies. Additionally, while the present invention has been described with the tubular slipper positioned about the shaft and the coupling member is fixed to the gear, the configuration may be reversed with the coupling member fixed to the shaft and the tubular slipper engaging the gear. In such a configuration, relative rotation between the tubular slipper and the coupling member causes the rollers to engage the side walls of the recesses and thereby expand the tubular slipper which in turn causes the slipper to lock to the gear.

1. A clutching device comprising:
a generally cylindrical tubular slipper having a friction surface and a bearing surface with an axial slit extending between the friction surface and a bearing surface, the bearing surface having radial projections which form axially oriented recesses, the tubular slipper including a first interlocking member; and
a generally cylindrical coupling member having a mounting surface and a bearing surface, the bearing surface having radial projections which form axially oriented recesses such that the tubular slipper recesses and the coupling member recesses form pockets in which said rollers are located, the coupling member including a second interlocking member,
wherein the tubular slipper and coupling member are axially displaceable relative to one another such that in a first position the first and second interlocking members are engaged such that the coupling member recesses and the tubular slipper recesses are maintained in circumferential alignment, and in a second position the first and second interlocking members are disengaged such that the coupling member and the tubular slipper are free to rotate relative to one another whereby the coupling member recesses and the tubular slipper recesses are circumferentially misalignable.

2. The device according to claim 1 wherein the first interlocking member is defined on a first radial flange extending from the tubular slipper and the second interlocking member is defined on a first radial flange extending from the coupling member.

3. The device according to claim 2 wherein in the first position, the tubular slipper first radial flange is axially aligned with the coupling member first radial flange.

4. The device according to claim 3 wherein the tubular slipper has a second radial flange spaced from the tubular slipper first flange and the clutching member has a second radial flange spaced from the coupling member first flange with the rollers positioned between the tubular slipper first and second flanges and between the coupling member first and second flanges, and wherein an axially acting spring is positioned between the rollers and the tubular slipper and coupling member second flanges such that the spring biases the tubular slipper and coupling member first flanges in to axial alignment.

5. The device according to claim 4 wherein the tubular slipper has an axial length greater than an axial length of the coupling member and a spacer is positioned between the tubular slipper second flange and the spring.

6. The device according to claim 2 wherein the first and second interlocling members are defined by a series of internal and external involute splines formed on the tubular slipper and coupling member first flanges.

7. The device according to claim 1 wherein in the second position, the coupling member rotates at a different speed than the tubular slipper thereby causing the rollers to move against the projections such that the tubular slipper is contracted.

8. The device according to claim 1 wherein in the second position, the coupling member rotates at a different speed than the tubular slipper thereby causing the rollers to move against the projections such that the tubular slipper is expanded.

9. The device according to claim 1 wherein the coupling member is displaced relative to the tubular slipper by a shift fork.

10. The device according to claim 1 wherein the tubular slipper is mounted about a shaft and the coupling member is fixed to a first gear rotatable about the shaft.

11. The device according to claim 1 wherein the coupling member is fixed to a shaft and the tubular slipper is engaged by a first gear rotatable about the shaft.

12. A clutching device for coupling a first gear to a shaft, the clutching device comprising:
a generally cylindrical tubular slipper having a friction surface and a bearing surface with an axial slit extending between the friction surface and a bearing surface, the friction surface engaging either the shaft or the first gear and the bearing surface having radial projections which form axially oriented recesses, the tubular slipper including a first interlocking member; and
a generally cylindrical coupling member having a mounting surface and a bearing surface, the mounting surface fixed to the other of the shaft or the first gear and the bearing surface having radial projections which form axially oriented recesses such that the tubular slipper recesses and the coupling member recesses form pockets in which said rollers are located, the coupling member including a second interlocking member,
wherein the tubular slipper and coupling member are axially displaceable relative to one another such that in a first position the first and second interlocking members are engaged such that the coupling member recesses and the tubular slipper recesses are maintained in circumferential alignment, and in a second position the first and second interlocking members are disengaged such that the coupling member and the tubular slipper are free to rotate relative to one another whereby the coupling member recesses and the tubular slipper recesses are circumferentially misalignable.

13. The device according to claim 12 wherein the first interlocking member is defined on a first radial flange extending from the tubular slipper and the second interlocking member is defined on a first radial flange extending from the coupling member.

14. The device according to claim 13 wherein in the first position, the tubular slipper first radial flange is axially aligned with the coupling member first radial flange.

15. The device according to claim 14 wherein the tubular slipper has a second radial flange spaced from the tubular slipper first flange and the clutching member has a second radial flange spaced from the coupling member first flange with the rollers positioned between the tubular slipper first and second flanges and between the coupling member first and second flanges, and wherein an axially acting spring is positioned between the rollers and the tubular slipper and coupling member second flanges such that the spring biases the tubular slipper and coupling member first flanges in to axial alignment.

16. The device according to claim 15 wherein the tubular slipper has an axial length greater than an axial length of the coupling member and a spacer is positioned between the tubular slipper second flange and the spring.

17. The device according to claim 13 wherein the first and second interlocking members are defined by a series of internal and external involute splines formed on the tubular slipper and coupling member first flanges.

18. The device according to claim 12 wherein the tubular slipper is positioned about the shaft and when in the second position, the coupling member rotates at a different speed than the tubular slipper thereby causing the rollers to move against the projections such that the tubular slipper is contracted against the shaft.

19. The device according to claim 12 wherein the tubular slipper is engaged with the first gear and when in the second position, the coupling member rotates at a different speed than the tubular slipper thereby causing the rollers to move against the projections such that the tubular slipper is expanded in to locked engagement with the first gear.

20. The device according to claim 12 wherein the coupling member is displaced relative to the tubular slipper by a shift fork.

21. The device according to claim 20 further including a second gear positioned about the shaft with a second clutching device, including a second tubular slipper and a second coupling member, therebetween and wherein the shift fork is moveable between a first position wherein neither the first or second gear is engaged, a second position wherein the first gear is engaged and a third position wherein the second gear is engaged.

22. The device according to claim 12 wherein the tubular slipper is mounted about the shaft and the coupling member is fixed to the first gear.

23. The device according to claim 12 wherein the coupling member is fixed to the shaft and the tubular slipper is engaged by the first gear.
